(19) United States
(12) Patent Application Publication
(10) Pub. No.: US 2025/0019202 A1
(43) Pub. Date: Jan. 16, 2025

(54) METHOD FOR DETECTING STATUS OF A BRAKE, CORRESPONDING SYSTEM, BRAKE FOR ELEVATOR, AND ELEVATOR SYSTEM

(71) Applicant: Otis Elevator Company, Farmington, CT (US)

(72) Inventor: Guosong Li, Tianjin (CN)

(21) Appl. No.: 18/769,852

(22) Filed: Jul. 11, 2024

(30) Foreign Application Priority Data
Jul. 12, 2023 (CN) 202310855657.5

(51) Int. Cl. B66B 1/32; B66B 5/00

(52) U.S. Cl. CPC B66B 1/32; B66B 5/0031

(57) ABSTRACT

A method for detecting the state of a brake, the method including adjusting the current used in a braking coil of the brake, so that a braking component of the brake moves away from a first position to a second position; collecting a first current of the braking coil when the braking component leaves the first position; determining a first electromagnetic force according to a preset relationship model based on the first current; calculating a second electromagnetic force based on the first electromagnetic force; adjusting the current in the braking coil when the braking component is in the second position, so that the braking component leaves the second position; collecting a second current of the braking coil when the braking component leaves the second position; and determining a gap from the preset relationship model based on the second electromagnetic force and the second current.

### FOREIGN PRIORITY

This application claims priority to Chinese Patent Application No. 202310855657.5, filed Jul. 12, 2023, and all the benefits accruing therefrom under 35 U.S.C. § 119, the contents of which in its entirety are herein incorporated by reference.

### TECHNICAL FIELD OF INVENTION

The present application refers to a technology related to brakes, and more specifically, referring to a technology for detecting the state of brakes, and elevator brakes and elevator systems using the technology.

### BACKGROUND OF THE INVENTION

In an elevator system, an elevator brake is a safety device used to prevent the elevator from falling too fast. Detecting the brake of an elevator, especially the wear condition of the brake, is an elementary and important part of the maintenance to ensure the safety of an elevator.

Currently, the current relies on regularly manual detection, which is, maintenance personnel use maintenance tools to manually determine the changes of the spring and gaps of an elevator brake, and then evaluate the state of the elevator. Taking manual detection once every two weeks as an example, it takes about 26 times to detect the wear condition of the brake of one elevator one year, and the cost of the working hours is several hundred yuan, which is time-consuming and laborious. Besides, manual operation by maintenance personnel cannot determine the loss of spring force.

Therefore, it is necessary to improve the detection of the wear condition and spring force of a brake.

### SUMMARY OF THE INVENTION

The present application provides a method for detecting the state of a brake to address at least one problem mentioned above.

According to the method for detecting the state of a brake provided by present application, where the brake comprises a braking component, a braking coil and an elastic component connected to the braking component, the method comprises adjusting a current in the braking coil for the brake, so that the braking component of the brake moves away from a first position to a second position; collecting the current in the braking coil when the braking component leaves the first position as a first current; determining a first electromagnetic force according to a preset relationship model based on the collected first current; calculating a second electromagnetic force based on the first electromagnetic force; adjusting the current in the braking coil to cause the braking component to leave the second position when the braking component is in the second position; collecting the current in the braking coil when the braking component leaves the second position as a second current; and determining a corresponding gap from the preset relationship model based on the second electromagnetic force and the second current; in which the first position and the second position are different positions where the braking component is located when the energized braking coil and the elastic component jointly act on the braking component.

According to the method for detecting the state of a brake of the present application, for example, the preset relationship model can be used to represent the relationship among the current of the braking coil, the electromagnetic force and the gap.

According to the method for detecting the state of a brake of the present application, for example, the calculating a second electromagnetic force based on the first electromagnetic force comprises: calculating the ratio of the first electromagnetic force to the first initial electromagnetic force to obtain the change of the Hooke's coefficient of the elastic component; calculating the second electromagnetic force based on the calculated ratio and the second initial electromagnetic force; and wherein the first initial electromagnetic force and the second initial electromagnetic force are predetermined electromagnetic forces.

According to the method for detecting the state of a brake of the present application, for example, the first position and the second position are respectively the position in a brake-picking state and the position in a brake-dropping state.

According to the method for detecting the state of a brake of the present application, in some instances, the first position is the position in a brake-picking state, and the second position is the position in a brake-dropping state. Accordingly, the adjustment of the current in the braking coil used for the brake to make the braking component of the brake leave the first position is achieved by reducing the current in the braking coil used for the brake to make the braking component of the brake leave the first position; the adjustment of the current in the braking coil to make the braking component leave the second position is achieved by increasing the current in the braking coil to make the braking component leave the second position.

According to the method for detecting the state of a brake of the present application, for example, the first initial electromagnetic force and the second initial electromagnetic force are determined according to the following method: measuring an initial gap of the brake; collecting the current in the braking coil when the braking component leaves the second position; determining a corresponding second initial electromagnetic force F_{pick_initial} according to the preset relationship model based on the determined initial gap and the collected initial current; determining a first initial electromagnetic force F_{drop_initial} when the braking component leaves the first position based on the determined second initial electromagnetic force F_{pick_initial}.

According to another aspect of the present application, a system for detecting the state of a brake is provided. The brake comprises a braking component, a braking coil and an elastic component connected to the braking component. The system comprises a memory for storing instructions; a current collection module for collecting the current in the braking coil for the brake; a controller configured to execute instructions stored in the memory to: adjust the current in the braking coil so that the braking component of the brake moves away from the first position to the second position; enable the current collection module to collect a first current of the braking coil when the braking component leaves the first position; for the first current, determine a first electromagnetic force according to a preset relationship model; calculate a second electromagnetic force based on the first electromagnetic force; adjust the current in the braking coil when the braking component is in the second position, so that the braking component leaves the second position; enabling the current collection module to collect a second current of the braking coil when the braking component leaves the second position; and based on the second electromagnetic force and the second current, determine the corresponding gap according to the preset relationship model; in which the first position and the second position are different positions where the braking component is located when the energized braking coil and the elastic component jointly act on the braking component.

In the above examples of the present application, the brake is, for example, a brake for an elevator, i.e., the brake can be an elevator brake.

According to still another aspect of the present application, an elevator brake is provided. The elevator brake comprises any one of the systems described herein for detecting the state of a brake; or the elevator brake is configured to be able to perform any one of the methods described herein for detecting the state of a brake.

An elevator system is further provided. The elevator system can comprise any one of the systems described herein for detecting the state of a brake. Or the elevator system can be configured to be able to perform any one of the methods described herein for detecting the state of a brake. Or the elevator can comprise the aforementioned elevator brake.

### BRIEF DESCRIPTION OF THE DRAWINGS

Embodiments of the application will be described in detail below with reference to the accompanying drawings to make the application fully understood, wherein:

FIG. 1 schematically depicts the structural diagram of a brake;

FIG. 2 is a schematic structural diagram of the brake when used as an elevator brake;

FIG. 3 schematically depicts that when the elevator car stops, the coupling state of the braking component and the brake wheel in a brake;

FIG. 4 schematically depicts the coupling state of the braking component and the static plate;

FIG. 5 is a flowchart of the method for detecting the state of a brake according to an example of the present application;

FIG. 6 schematically depicts a relationship among the gap, the current of the braking coil, and the electromagnetic force under a preset relationship model;

FIG. 7 is a schematic diagram of the process for obtaining the initial data according to some examples of the present application;

FIG. 8 is a schematic structural diagram of the system for detecting the state of a brake according to an example of the present application.

### DETAILED DESCRIPTION OF THE INVENTION

In order to make the purpose, technical solutions and advantages of the embodiments of the present application clearer, the following will give a clear and complete description of the embodiments of the present application with reference to the accompanying drawings. It should be noted that the described embodiments are only part of the embodiments of the technical solutions of the present application, not all of them. All other embodiments obtained by those skilled in the art based on the embodiments described in the present application without any creative efforts are covered by the protection scope of the present application.

The terms “first”, “second” and the like in the description, claims and drawings of the present application are used to distinguish similar objects, rather than to describe a specific order or sequence. It is to be understood that the data used as such are interchangeable under suitable circumstances, so that the embodiments of the present invention described herein can be practiced in orders other than those illustrated or described herein. In addition, “first” and “second” are used for descriptive purposes only, and should not be interpreted as indicating or implying relative importance or implicitly indicating the quantity of the indicated technical features. Therefore, the features defined as “first” and “second” may explicitly or implicitly include one or more of the features. In the description of the embodiments of the present application, unless otherwise specified, “multiple” means two or more than two.

The term “example” or “for example” or “exemplarily” used hereinafter means “serving as an example, embodiment or illustration”. Any embodiment described as “example” or “for example” or “exemplarily” is not necessarily to be construed as superior to or better than other embodiments.

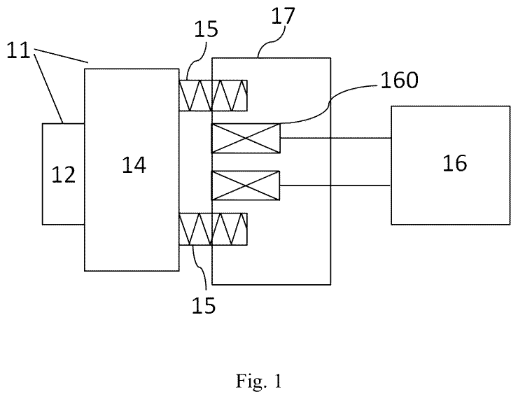

FIG. 1 is a structural schematic diagram of a brake, which is only used to illustrate the function of the brake, rather than to illustrate the actual geometry of the brake. As shown in FIG. 1, the brake comprises a braking component 11, an elastic component 15 like a spring, a static plate 17 and a drive circuit 16. The braking component 11 comprises a brake lining plate 12 and an armature plate 14 that are coupled together, where the brake lining plate 12 is arranged on the side facing the braking component and the armature plate 14 is arranged on the side facing the static plate 17. The drive circuit 16 comprises a driving coil 160.

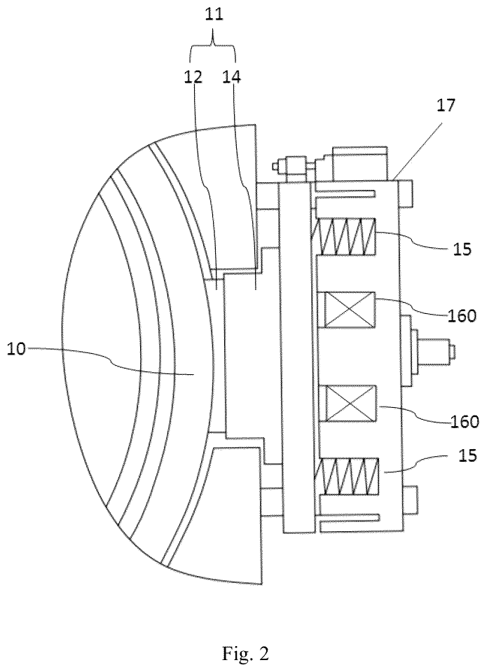

Brakes can be applied to different equipment/systems to brake the equipment/system as desired. By way of example and without limitation, the present disclosure will describe in detail the application of the brake to an elevator as an example, i.e., as an elevator brake. FIG. 2 is a simple schematic diagram of the brake when used as the elevator brake (that is, the component to be braked is an elevator car). As shown in FIG. 2, the brake lining plate 12 of the brake is pressed against a brake wheel 10 to realize the braking by the frictional force between them. Various embodiments according to the present application will be described below by taking a brake being an elevator brake as examples.

It should be noted that the names of the components of the brake herein may be different in actual application due to various factors such as the application environment. For example, the armature plate 14 may be referred to as the iron plate, the movable plate, etc.; the brake lining plate 12 may be referred to as the brake shoe, the brake lining, etc.; the brake wheel 10 may also be referred to as the sheave, the brake drum, etc. It should be understood that the brake actually includes more parts than the structure illustrated herein. The illustration of the brake in the present application is only for explaining its principle and working process related to the present application in a concise and intuitive manner, not for illustrating or limiting the specific structure or shape of the brake.

One end of the spring 15 is fixed to the static plate 17, and the other end is disposed on the armature plate 14. The static plate 17 remains in a static state all the time. The drive circuit 16 is used to supply power to the coil 160. The drive circuit 16 (see FIG. 1) is configured to supply power to the braking coil 160 when the braking is released, and the coil 160 accordingly generates a magnetic field attracting the armature plate 14. The attracted armature plate 14 overcomes the acting force of the spring 15 and moves along the direction to the coil 160 so that the braking component 11 leaves the brake wheel 10, thereby releasing the braking. In the present application, the electromagnetic force means the force applied by the magnetic field generated by energized coil 160 to the braking component 11, especially, to armature plate 14. Under the action of an electromagnetic force, the braking component 11 moves away from brake wheel 10 until it is coupled with static plate 17 and no longer moves. At that time, the braking component is in a brake-picking state, and the position where the braking component locates is called a position in the brake-picking state. The drive circuit 16 is configured to cut off the power supply to the braking coil 160 during braking, and the electromagnetic force acting on the armature plate 14 disappears. Then, the armature plate 14 moves along the direction to the brake wheel 10 under the action of spring 15, such that the brake lining plate 12 of the braking component is pressed against the brake wheel 10. The braking of the brake wheel 10 is realized by the friction force between the brake lining plate 12 and the brake wheel 10. At that time, the braking component 11 is in a brake-dropping state, and the position where the braking component locates is called the position in the brake-dropping state. In use, the brake lining plate 12 is gradually worn due to the friction with brake wheel 10. Increased wear could damage the braking function of the brake. Thus, it is necessary to check or monitor the wear of brake lining plate 12. It should be noted that, the brake-dropping state in the present disclosure is also referred to as the closed state of the brake, and the brake-picking state is also referred to as the open state of the brake.

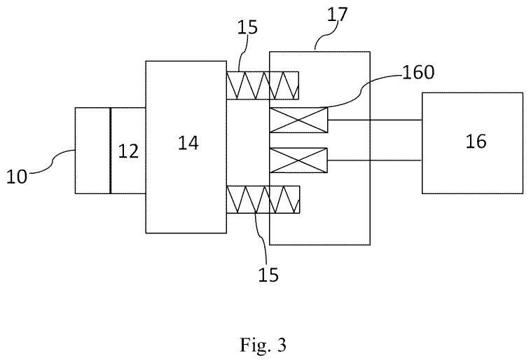

In the example of being applied to the elevator, a controller of the brake shown in FIG. 1 controls, when the car of the elevator is about to stop, the controller of a brake the drive circuit 16 to cut off the current to the braking coil 160, and the electromagnetic force attracting the armature plate 14 is thus disappeared. In this case, the force of the spring 15 acting on the braking component 11 pushes the braking component 11 to move to the brake wheel 10 until the brake lining plate 12, which is fixedly connected with armature plate 14, is pushed onto the brake wheel 10, and the braking force generated by the friction between brake lining plate 12 and brake wheel 10 makes the car stop. FIG. 3 schematically depicts the coupling of the braking component 11 of the brake and the brake wheel 10 when the car stops, i.e., the brake-dropping state of the braking component 11.

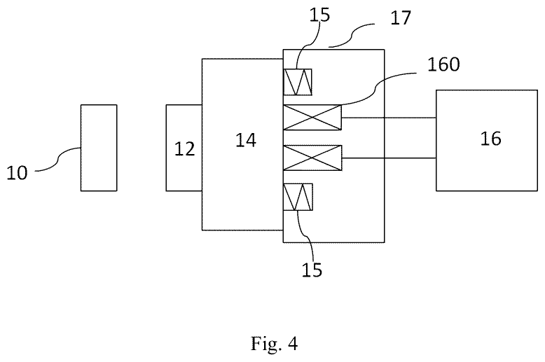

When the car is about to move, for example, the controller of the brake controls the drive circuit 16 to supply power to the coil 160, and the electromagnetic force on the armature plate 14 applied by the magnetic field generated by coil 160 take the brake lining plate 12 away from the brake wheel 10 to release the braking. the armature plate 14 takes brake lining plate 12 to move away from the brake wheel 10 until it is blocked by static plate 17, and the armature plate 14 stops moving. FIG. 4 schematically depicts that the braking component couples to the static plate 17, namely, the brake-picking state of the braking component.

Actually, there are more parts involved in controlling and moving the car of the elevator, and the operation is relatively complicated. The detailed mechanical structure of the elevator and the control of the car will not be explained further herein.

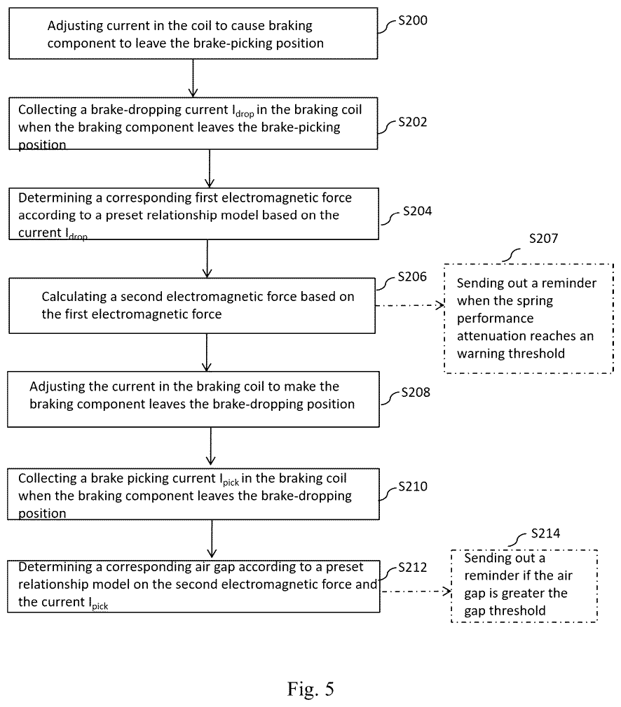

FIG. 5 is a flowchart of a method for detecting a state of a brake according to examples of the present application. As an example, the brake is a brake of an elevator and the method is used to detect the state of the brake of the elevator. The following description can also refer to FIG. 2 to FIG. 4.

It should be understood that the detection of the brake is usually made when nobody use the elevator, for example at nights, rather than the elevator running normally. Therefore, the method for detecting the state of a brake according to the examples of the present application is at least performed when the elevator does not carry users. According to the method, the degree of wear of the braking component (such as the degree of wear of brake lining plate 12 in FIG. 2) and/or the performance of the spring can be determined through the change of the gap, wherein the gap is usually an air gap.

In the method shown in FIG. 5, the first position is the position in the brake-picking state, and the second position is the position in the brake-dropping state. However, it is not limited thereto. In some possible examples, the first position is the position in the brake-dropping state, while the second position is the position in the brake-picking state.

At step S200, the current in the braking coil used for the brake is adjusted to enable the braking component of the brake to leave the position in the brake-picking state.

For example, FIG. 4 illustrates the brake-picking state of the braking component 11 of the elevator brake. In this state, the position of braking component 11 is the position under the brake-picking state. When reducing the current in braking coil 160, the force (i.e., the electromagnetic force) on the braking component 11 generated by the electric field of the current becomes smaller, so that the braking component 11 can leave the static plate 17 when the electromagnetic force begins to be less than the acting force of spring 15.

At step S202, when the braking component leaves the position in the brake-picking state, the current in the braking coil is collected as the first current I_{drop}.

The moment of collecting the first current I_{drop} is the moment when the electromagnetic force starts to be less than the acting force of the spring. At that time, the braking component starts to moving from the static plate under the acting force of the spring. To be specific, the first current I_{drop} is the current collected at the moment when the braking component 11 is separated from the static plate 17. After the braking component 11 is separated from the static plate 17, it will switch to the brake-dropping state. Therefore, the position, where the first current I_{drop} is collected when the braking component 11 is separated from static plate 17, can also be regarded as the initial position in the brake-dropping state, and the first current I_{drop} can be also referred to as the brake-dropping current I_{drop} accordingly. The collecting of the first current I_{drop} can be realized in different ways, for example, obtaining the current by using a current sensor or by using a current sampling circuit. When the method is implemented in the elevator brake, the moment when the braking component leaves the position in the brake-dropping state can be determined by a microswitch placed in the elevator brake, and the current at this moment is the first current. In some cases, it is also possible to determine the position change of the braking component by using the sudden change in the current.

At step S204, a first electromagnetic force is determined according to a preset relationship model based on the collected first current I_{drop}.

Exemplarily, the relationship model is a preset model, which can be modeled and trained based on data before the brake is put into actual use. The data used for modeling and training the preset model can include test data of the brake. The test data of the brake refers to the data obtained during testing of the brake before it is put into use, indicating the relationship among the gap, the current of the braking coil and the electromagnetic force. It can be understood that test data can be adjusted repeatedly. In some cases, the test data can also include historic operation data of the brake may also be included. The historic operation data of the brake refers to, for example, the data that is related to such type of the brake and have been generated by equipments or systems with such type of the brake in operation. In some cases, the data collected after the brake is put into use can also be considered as training data to optimize the preset model. According to an example of the present application, a gap corresponding to the first current can be the smallest gap in the model, or a relatively small gap value. Thus, based on the first current and the gap corresponding to the first current, the corresponding first electromagnetic force can be determined from the model that provides the relationship among the gap, the current of the braking coil and the electromagnetic force.

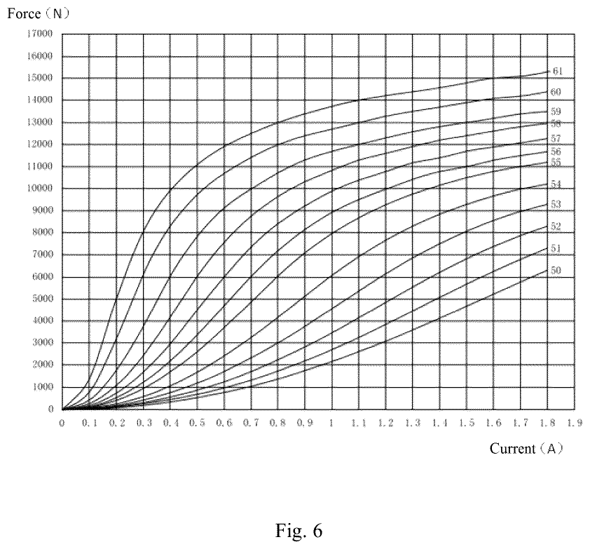

FIG. 6 schematically depicts an example of the relationship among the gap, the current of the braking coil and the electromagnetic force under a preset relationship model, and the data therein are only exemplary and not limiting. As shown in FIG. 6, the horizontal axis shown in the figure represents the current of the coil in Ampere (A); the vertical axis shown in the figure represents the braking force in Newton (N). The various curves shown in the figure correspond to different gaps, where the gap (unit: mm) values respectively represented by curves 50, 51, 52, 53, 54, 55, 56, 57, 58, 59, 60 and 61 are 0.8, 0.7, 0.6, 0.5, 0.4, 0.02, 0.05, 0.1, 0.15, 0.2, 0.25, 0.3. Under the relationship model shown in FIG. 6, the gap corresponding to the first current is, for example, the gap corresponding to the curve 55, which is 0.02 mm.

At step S206, a second electromagnetic force is calculated based on the determined first electromagnetic force.

For example, the second electromagnetic force is calculated by the controller of the brake or the elevator controller according to equation (1) and equation (2) based on the first electromagnetic force. Specifically, based on the ratio of the first electromagnetic force to the first initial electromagnetic force, the change ratio of the Hooke's coefficient of the spring 15 can be determined according to equation (1):

$$Hp = {F}_{drop\_now} / {F}_{drop\_initial} \qquad ( 1 )$$

Where Hp represents the change ratio of the Hooke's coefficient of the spring 15, F_{drop_now} represents the determined first electromagnetic force, and F_{drop_initial} represents the first initial electromagnetic force.

Also, based on the second electromagnetic force and the second initial electromagnetic force, the change ratio of Hooke's coefficient can be determined according to the equation (2):

$$Hp = {F}_{pick\_now} / {F}_{pick\_initial} \qquad ( 2 )$$

Where F_{pick_now} represents the second electromagnetic force to be determined, and F_{drop_initial} represents the second initial electromagnetic force.

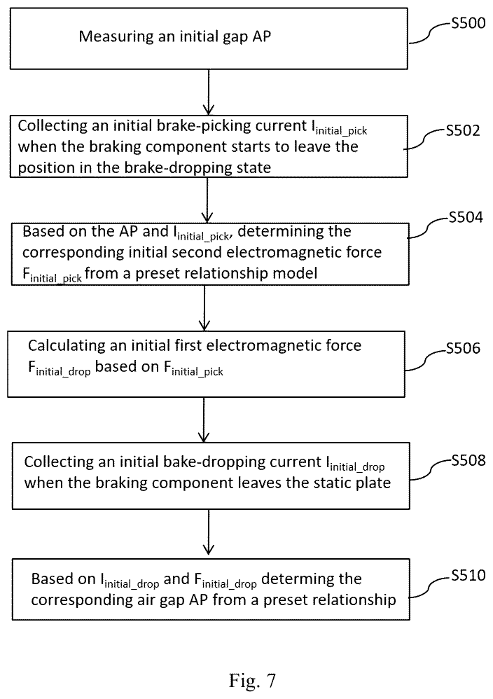

The second electromagnetic force will be explained hereinafter, and the process for determining the first initial electromagnetic force F_{drop_initial} and the second initial electromagnetic force F_{pick_now} will also be explained below with reference to FIG. 7. It can be understood that the change of Hooke's coefficient can indicate the change of the performance of the spring 15.

At step S208, the current in the braking coil for the brake is adjusted to make the braking component of the brake leave the position in the brake-dropping state. It can be understood that after leaving the position in the brake-picking state, the braking component of the brake will switch to the brake-dropping state to brake the brake wheel, and the braking component at that time is in the position in the brake-dropping state.

For example, FIG. 3 schematically depicts the brake-dropping state of the braking components in an elevator brake. The current in the braking coil 160 can be gradually increased to strengthen the generated magnetic field and the electromagnetic force acting on the braking component is enhanced. When the electromagnetic force begins to be greater than the acting force of the spring 15, the braking component 11 will start to leave its current position in the brake-dropping state, and switch to the brake-picking state.

At step S210, when the braking component leaves the position in the brake-dropping state, the current in the braking coil is collected as the second current I_{pick}.

Hence, the moment of collecting the second current I_{pick} is the moment when the electromagnetic force starts to be greater than the acting force of the spring. At that time, the braking component 11 starts to leave the brake wheel 10 under the acting force of the electromagnetic force. To be specific, the second current I_{pick} is the current obtained at the moment when the braking component 11 is separated from the brake wheel 10. After the braking component 11 is separated from brake wheel 10, the state is changed to the brake-picking state. Therefore, the position at which the second current is obtained when the braking component 11 is separated from brake wheel 10 can also be regarded as the initial position in the brake-picking state. The second current I_{pick} is also referred to as the brake-picking current I_{pick} accordingly. The way used to collect the first current I_{drop} can be applied to collect the second current I_{pick}, and will not be repeated here.

At step S212, the gap corresponding to the second electromagnetic force and the second current I_{pick} is determined from the relationship model based on the calculated second electromagnetic force and the second current I_{pick}.

For example, based on the calculated second electromagnetic force and the second current I_{pick}, the gap corresponding to them can be determined from the relationship model.

As described above, the braking is achieved by the friction between the brake wheel 10 and the brake lining plate 12 of the braking component. As the wear of brake lining plate 12 increases, the gap between the armature plate 14 and the static plate 17 of the braking component will increase in the brake-dropping state, in which said gap also corresponds to the gap between the brake lining plate 12 and the brake wheel 10 in the brake-picking state. Therefore, the wear condition of the brake lining plate 12 can be determined from the condition of the gap increasing. In addition, in the process, the change of the spring force can also be figured out from the change of the Hooke's coefficient of the spring, thereby knowing the change in the performance of spring 15 and monitoring the spring 15 aging condition.

According to an example of the present application, the method further comprises sending a reminder when the determined gap is greater than a gap threshold, as shown at step S214 represented by the dotted box. The gap threshold is preset which represents the maximum acceptable gap. If the detected gap is greater than the gap threshold, it indicates that the wear of the brake lining plate of the braking component may affect the braking function. The reminder can be sent out in a visible way, or in an audible way, or in the combination the both way. For example, the reminding function can be realized by displaying the reminder on a screen, or achieved by means such as buzzing, or the combination thereof. In addition, in some examples, it is also possible to determine the attenuation of the spring performance on the basis of the change of the Hooke's coefficient. In the event that the change indicates that the attenuation of the spring performance reaches a warning threshold, which is preset for the change of the spring performance, a reminder can also be sent out, for example as shown at step S207.

The importance of the safe operation of an elevator is self-evident. Currently, the wear of a brake is at least manually checked in every two weeks. When the method for detecting the state of the brake as described herein is implemented in an elevator, for example, in the form of software, the detection can be performed whenever necessary. By changing the magnitude of the current input into the braking coil to make the braking component move between the two positions, I_{drop} and I_{pick} are detected respectively, and the gap is determined according to the relationship model, thereby determining the wear of the braking component based on the gap. In the determination process, it is no longer necessary to manually insert a detection piece into the gap of the brake to judge the wear of the brake lining plate by detecting the width of the gap, which saves labor costs. Moreover, the method according to the present application can be performed whenever needed by controlling the elevator, enabling such detection to be carried out more frequently, which contributes to better ensure the safety of elevator operation.

The method for detecting the state of the brake in FIG. 5 can be configured into a controller of the brake as a software module implemented by program instructions, so that it can be performed when the brake state needs to be detected, or automatically performed periodically according to the settings. In some cases, the software module may be configured into a separate hardware, such as a processor. In this case, the separate hardware with the software module can be combined to existing brakes, or other equipment using brakes such as elevators and or elevator control systems, so as to realize the above detection process.

Additionally, it should be understood that an elevator brake or a brake used for an elevator can comprise braking components disposed on both sides of brake wheel 10. The method according to the present application can be used to detect the braking components disposed on one side of the brake wheel 10 separately. For example, the braking component on one side (such as the left side) of the brake wheel 10 is kept in the position in the brake-dropping state, i.e., not supplying power to the braking coil on this side, while the other side (right side) executes the method in FIG. 5 to determine the wear of the brake lining plate 12 by detecting the gap on this side (right side). The braking component of the side (right side) is then kept in the position in the brake-dropping state, and the braking component of the other side (left side), which is originally in the brake-dropping state, performs the method in FIG. 5. Another possibility is to stop the elevator by using the traction motor of the elevator, and then to carry out the method in FIG. 5 on the two sides respectively or simultaneously.

The process for obtaining the initial data, such as the first initial electromagnetic force F_{drop_initial}, and the second initial electromagnetic force F_{pick_initial}, etc., will be described below with reference to FIG. 7.

As shown in FIG. 7, at step S500, an initial gap is measured and stored. The initial gap (represented by AP) refers to the distance between the static plate 17 and the armature plate 14 of braking component 11 when the elevator brake is in the brake-dropping state, namely, when the braking component 11 brakes the brake wheel 10. The measurement of the initial gap can be performed manually, for example, according to the method of manually measuring the gap of an elevator brake with a detection piece. The measured initial gap AP is stored into the initial data record. At step S502, the current in the braking coil 160 for the brake is increased to make the braking component 11 of the brake leave the position in the brake-dropping state. When the braking component starts to leave the position in the brake-dropping state, i.e., the moment leaving the brake wheel 10, the current in the braking coil 160 is collected as the initial second current I_{initial_pick}, namely the initial brake-picking current I_{initial_pick}. In other words, the way for the collection of the brake-picking current is same as the way for the collection of the brake-picking current described above with reference to FIG. 5. At step S504, based on the determined initial gap AP and the collected initial brake-picking current I_{initial_pick}, their corresponding initial second electromagnetic force F_{initial_pick} is determined, for example, from the relationship model in FIG. 6.

Simply put, after the brake lining plate 12 of braking component 11 starts to leave the brake wheel 10, it moves away from the brake wheel 10, and then the state is changed to the brake-picking state from the brake-dropping state. Thus, the braking component 11 enters into the position in the brake-picking state, that is, the armature plate 14 and static plate 17 are coupled.

At step S506, based on the determined initial second electromagnetic force F_{initial_pick}, the initial first electromagnetic force F_{initial_drop} when the braking component leaves the position in the brake-picking state is calculated according to equation (3).

$${F}_{initial\_drop} = {F}_{initial\_pick} + k * AP \qquad ( 3 )$$

Where k is the Hooke's coefficient of the spring, and AP is the value of the gap measured at step S500. The gap AP is also the distance that the spring moves from the brake-picking state of the braking component to the brake-dropping state.

At step S508, the current in braking coil 160 is reduced so that the braking component 11 leaves the position in the brake-picking state, and the current in the braking coil when the braking component 11 leaves the static plate 17 is collected as the initial second current I_{initial_drop}, i.e., the initial brake-dropping current I_{initial_drop}.

At step S510, based on the collected initial brake-dropping current I_{initial_drop} and the determined initial first electromagnetic force F_{initial_drop}, their corresponding gap AP is determined from the preset relationship model, i.e., the gap between braking component 11 and brake wheel 10. It should be noted that the gap AP may be used as the gap corresponding to the first current in step S204 of the method illustrated in FIG. 5. In addition, in some possible cases, the gap AP between braking component 11 and brake wheel 10 can also be used to determine the change in the performance of the spring.

The process discussed with reference to FIG. 7 is used to provide the initial values for the first electromagnetic force and the second electromagnetic force, and can also provide gaps corresponding to the first current and the second electromagnetic force. Although the process shown in FIG. 7 is usually performed to calibrate the initial value before the elevator is put into official use, it can also be performed again as needed to calibrate new initial values. It can be understood that all the calibrated initial values can be stored, for example, stored in a memory that can be read by the controller which performs the method shown in FIG. 5, or stored in the storage included by the controller (if any) which performs the method shown in FIG. 5.

According to some examples of the present application, temperature may also be introduced to the preset relationship model. That is, the influence of temperature on the gap and the electromagnetic force, etc. is considered by the relationship model. Namely, the temperature parameter can be added in determining the preset relationship model. As such, when performing the detection method shown in FIG. 5, the temperature at that time can be measured simultaneously. Therefore, when determining the gap according to the relationship model, the temperature is also included by the input in addition to the collected current and the determined electromagnetic force.

According to some other examples of the present application, it is considered that the shape of brake wheel 10 may be deformed during use, such as changing from a circle into an ellipse, which might change the contact surface between it and the braking component. Thus, correction factor can be introduced into the preset relationship model through the encoder angle information. In this way, for example, the brake wheel 10 can be divided according to the angles, for example, divided according to 0 degree, 90 degree, 180 degree and 270 degree. When performing the process as shown in FIG. 7 to set the initial values, the initial gap values corresponding to the four angles are determined. When performing the detection method shown in FIG. 5, the gap values corresponding to the four angles are also determined, and the determined values are compared with the initial values to find out the changes of the angles and its influence on the gap. Accordingly, when determining the gap on the relationship model, in addition to the collected current and the determined electromagnetic force, the input can also consider the influence of the deformation of brake wheel 10 on the gap by including the encoder angle information of brake wheel 10. Furthermore, for example, the absolute angle information of the encoder can be set or trained to correspond to the brake-picking current and the brake-dropping current respectively, so that the judgement and monitor of the wear of the brake lining plate of the braking component will be more comprehensive.

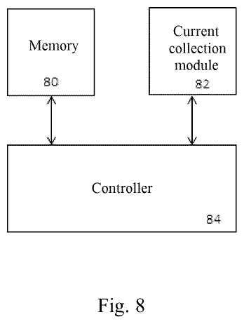

FIG. 8 is a schematic structural diagram of a system for detecting the state of a brake according to an example of the present application. As shown in FIG. 8, the system comprises a memory 80 (e.g., RAM), a current collection module 82 (e.g., a current sensor) and a controller 84 (e.g., a microprocessor based controller). The memory 80 stores instructions, preset relationship models, and other stored data (if any). The current collection module 82 is used for collecting the current in the braking coil of the brake. The controller 84 is configured to execute the instructions, and perform the method for detecting the state of a brake as described in any of the examples above when executing the instructions. According to examples of the present application, the system for detecting the state of a brake shown in FIG. 8 further comprises an output module (e.g., a network adapter, network interface card, wireless network adapter, etc.) which is configured to output a reminder message when the determined gap is greater than the gap threshold. In addition, in some cases, the output module is also configured to output reminder when, for example, a change in spring performance is determined based on a change in Hooke's coefficient, and the change indicates that the attenuation of spring performance reaches a warning threshold. In some examples, it is also used to output the determined gaps. The output module may comprise a display screen, a communication module or a combination thereof. The communication module can transmit the determined information on gaps and/or reminder information to a remote control terminal.

The system shown in FIG. 8 can be applied in an elevator as a system for detecting an elevator brake. In the example, instructions and relationship models can be stored in an existing memory of an elevator. The current collection module 82 can be an existing current collection part of an elevator. Controller 84 can also be an existing controller of an elevator, such as an elevator system controller or a controller of an elevator brake, etc. The output module can be an existing display screen of an elevator system, and, in some cases, further comprises an existing communication module of an elevator system.

The present application further provides an elevator brake comprising a system for detecting the state of a brake such as shown in FIG. 7. Alternatively, the elevator brake is configured to perform the method for detecting the state of a brake described in any examples above. Compared with existing elevator brakes, the elevator brake according to the present application does not require maintenance personnel to come to the site and manually detect the degree of wear of the brake, but can be performed automatically according to needs or according to a preset detection cycle.

The present application further provides an elevator system, which comprises, for example, the system for detecting the state of a brake as shown in FIG. 8, or is configured to perform the method for detecting the state of a brake described in any of the examples above, or comprises the elevator brake according to the examples of the present application.

In the description of the above examples in the present application, the steps are not necessarily performed in the given order, but can be adjusted as needed. For example, step S208 in FIG. 5 may be performed before step S206, or performed simultaneously with step S206. In addition, the technical features in all examples of the present application can be combined with each other to form new embodiments of the present application under the condition of no conflict.

While specific embodiments of the present application have been shown and described in detail to illustrate the principles of the present application, it should be understood that the application may be practiced otherwise without departing from such principles.

What is claimed is:

1. A method for detecting a state of a brake which comprises a braking component, a braking coil and an elastic component connected to the braking component, the method comprising:
adjusting a current in the braking coil such that the braking component moves away from a first position to a second position;
collecting a first current in the braking coil when the braking component leaves the first position;
determining a first electromagnetic force according to a preset relationship model based on the first current;
calculating a second electromagnetic force based on the first electromagnetic force;
when the braking component is in the second position, adjusting the current in the braking coil to cause the braking component to leave the second position;
collecting a second current in the braking coil when the braking component leaves the second position; and
determining a gap from the preset relationship model based on the second electromagnetic force and the second current;
wherein the first position and the second position are different positions where the braking component is located when the energized braking coil and the elastic component jointly act on the braking component.

2. The method according to claim 1, wherein the preset relationship model is used to represent the relationship among the current of the braking coil, the electromagnetic force and the gap.

3. The method according to claim 2, wherein the preset relationship model further comprises introducing encoder angle information and/or introducing temperature information when determining the gap.

4. The method according to claim 1, wherein the calculating a second electromagnetic force based on the first electromagnetic force comprises:
calculating the ratio of the first electromagnetic force to a first initial electromagnetic force to obtain the change of the Hooke's coefficient of the elastic component;
calculating the second electromagnetic force based on the calculated ratio and a second initial electromagnetic force; and
wherein the first initial electromagnetic force and the second initial electromagnetic force are predetermined electromagnetic forces.

5. The method according to claim 4, wherein the first position and the second position are respectively one of the positions in a brake-picking state and in a brake-dropping state.

6. The method according to claim 5, wherein the first position is the position in the brake-picking state, and the second position is the position in brake-dropping state;
the adjusting the current in the braking coil such that the braking component moves away from the first position comprises: reducing the current in the braking coil for the brake to cause the braking component of the brake to leave the first position; and
the adjusting the current in the braking coil to cause the braking component to leave the second position comprises: increasing the current in the braking coil to cause the braking component to leave the second position.

7. The method according to claim 6, wherein the first initial electromagnetic force and the second initial electromagnetic force are determined by the following process:
measuring an initial gap of the brake;
collecting an initial current in the braking coil when the braking component leaves the position in the brake-dropping state;
determining a corresponding second initial electromagnetic force according to the preset relationship model based on the determined initial gap and the collected initial current;
based on the second initial electromagnetic force, calculating a first initial electromagnetic force when the braking component leaves the position in the state of picking the brake.

8. The method according to claim 1, further comprising:
sending out a reminder when the determined gap is greater than a gap threshold.

9. The method according to claim 4, further comprising:
sending out a reminder when the change of the Hooke's coefficient indicates that the change in the performance of the elastic component reaches an warning threshold.

10. A method according to claim 1, wherein the brake is a brake for an elevator.

11. A system for detecting the state of a brake, in which the brake comprises a braking component, a braking coil and an elastic component connected to the braking component, the system comprising:
a memory for storing instructions;
a current collection module for collecting the current of the braking coil;
a controller configured to execute instructions stored in the memory to:
adjust the current in the braking coil, so that the braking component of the brake moves away from the first position to the second position;
enable the current collection module to collect a first current in the braking coil when the braking component leaves the first position;
based on the first current, determine a first electromagnetic force according to a preset relationship model;
calculate a second electromagnetic force based on the first electromagnetic force;
adjust the current in the braking coil to cause the braking component to leave the second position, when the braking component is in the second position;
enable the current collection module to collect a second current in the braking coil when the braking component leaves the second position; and
based on the second electromagnetic force and the second current, determine a corresponding gap according to the preset relationship model;
wherein the first position and the second position are different positions where the braking component is located when the energized braking coil and the elastic component jointly act on the braking component.

12. The system according to claim 11, further comprising an output module; and
where the controller is further configured to execute the instructions to enable the output module to send out a reminder when the determined gap is greater than the gap threshold.

13. The system according to claim 12, wherein the controller is configured to execute the instructions to calculate the second electromagnetic force based on the first electromagnetic force by following process:
calculating the ratio of the first electromagnetic force to a first initial electromagnetic force to obtain the change of the Hooke's coefficient of the elastic component;
calculating the second electromagnetic force based on the calculated ratio and a second initial electromagnetic force; and
wherein the first initial electromagnetic force and the second initial electromagnetic force are predetermined electromagnetic forces.

14. The system according to claim 13, wherein the controller is further configured to execute the instructions to:
send out a reminder when the change of the Hooke's coefficient indicates that the change in the performance of the elastic component reaches an warning threshold.

15. The system according to claim 11, wherein the first position is the position in the brake-picking state, and the second position is the position in the brake-dropping state.

16. The system according to claim 11, wherein the brake is a brake for an elevator.

17. An elevator brake, wherein the elevator brake comprises the system according to claim 11.

18. An elevator system, wherein the elevator system comprises the system according to claim 11.
